(19) United States
(12) Patent Application Publication
(10) Pub. No.: US 2016/0095057 A1
(43) Pub. Date: Mar. 31, 2016

(54) SYSTEMS AND METHODS FOR DISTRIBUTING OFFLOAD SERVICE PROCESSING

(71) Applicants: WEY-YI W. GUY, Beaverton, OR (US); Mark Y. Tung, Hillsboro, OR (US)

(72) Inventors: WEY-YI W. GUY, Beaverton, OR (US); Mark Y. Tung, Hillsboro, OR (US)

(21) Appl. No.: 14/498,576

(22) Filed: Sep. 26, 2014

(51) Int. Cl. H04W 52/02; H04L 29/08; H04L 12/26; H04W 8/24

(52) U.S. Cl. CPC H04W 52/0219; H04W 8/24; H04L 67/1008; H04L 43/04; H04L 43/08

(57) ABSTRACT

The present disclosure relates to computer-implemented systems and methods for transmitting and receiving audio and video data. A method may include receiving, by a device including one or more processors and a radio transceiver, an indication that the device is a short-range communication second device. The method may also include determining, by a computer including one or more processors, that processing of a job associated with a first service is to be offloaded from the one or more processors. Furthermore, the method may include identifying a first device including a first offload processing component and a second device including a second offload processing component. Additionally, the method may include determining, based at least in part on first offload capability information and second offload capability information, whether to process the job via the first offload processing component or via the second offload processing component.

### TECHNICAL FIELD

The present disclosure generally relates to wireless communication, and in particular, to distributing offload service processing.

### BACKGROUND

Recently, techniques related to offload processing from the main processor in a device has experienced an increase in usage. Such techniques may lower power consumption of the device, but may also experience a corresponding decrease in overall processing power. To this end, leveraging processing power of other devices may improve efficiency with respect to offload processing.

### BRIEF DESCRIPTION OF THE DRAWINGS

Reference will now be made to the accompanying figures and diagrams, which are not necessarily drawn to scale, and wherein:

FIG. 1 is a schematic block diagram of an illustrative networked architecture in accordance with one or more example embodiments of the disclosure.

FIG. 2 is a more detailed schematic block diagram of an illustrative system architecture in accordance with one or more example embodiments of the disclosure.

FIG. 3 show a flow diagram for distributing offload service processing, according to one or more example embodiments.

FIG. 4 shows a flow diagram for distributing offload service processing, according to one or more example embodiments.

### DETAILED DESCRIPTION

In the following description, numerous specific details are set forth. However, it should be understood that embodiments of the present disclosure may be practiced without these specific details. In other instances, well-known methods, structures, and techniques have not been shown in detail in order not to obscure an understanding of this description. References to “one embodiment,” “an embodiment,” “example embodiment,” “various embodiments,” and so forth indicate that the embodiment(s) of the present disclosure so described may include a particular feature, structure, or characteristic, but not every embodiment necessarily includes the particular feature, structure, or characteristic. Furthermore, repeated use of the phrase “in one embodiment” does not necessarily refer to the same embodiment, although it may.

As used herein, unless otherwise specified, the use of the ordinal adjectives “first,” “second,” “third,” etc., to describe a common object merely indicates that different instances of like objects are being referred to and are not intended to imply that the objects so described must be in a given sequence, either temporally, spatially, in ranking, or in any other manner.

As used herein, unless otherwise specified, the term “server” may refer to any computing device having a networked connectivity and configured to provide one or more dedicated services to clients, such as a mobile device. The services may include storage of data or any kind of data processing. One example of the server may include a web server hosting one or more web pages. Some examples of web pages may include social networking web pages. Another example of a server may be a cloud server that hosts web services for one or more computer devices.

As used herein, unless otherwise specified, the term “receiver” may refer to any device or component capable of receiving data, signals, information, etc. For example, a receiver may include an antenna or any other receiving device.

As used herein, unless otherwise specified, the term “transmitter” may refer to any device or component capable of transmitting data, signals, information, etc. For example, a transmitter may also include an antenna or any other transmission device.

As used herein, unless otherwise specified, the term “transceiver” may refer to any device or component capable of performing the functions of a receiver and/or a transmitter. For example, transceivers may include and/or may otherwise be associated with components that include, antennas, amplifiers, filters, modulation and/or demodulation components, analog-to-digital converters, digital-to-analog converters, and/or the like. Furthermore, the transceivers described herein may be configured to transmit data using various types of transmission protocols, such as Dedicated short-range communication (DSRC) protocols, WiFi radio protocols, Bluetooth radio protocols, Bluetooth Low-Energy protocols, Long-Term Evolution (LTE) protocols, LTE-Advanced protocols, Global System for Mobile Communication (GSM) protocols, Code Division Multiple Access (CDMA) protocols, and/or the like.

According to certain embodiments, the functionality provided by the receiver and the transmitter may be included in a single transceiver device.

The present disclosure relates to computer-implemented systems and methods for distributing offload service processing. According to one or more embodiments of the disclosure, a device is provided. The device may include at least one antenna, a radio transceiver, at least one processor, and at least one memory for storing data and computer-executable instructions. Additionally, the device may also include a first offload processing component to execute the computer-executable instructions. Furthermore, the offload processing component may be configured to execute the instructions to determine that processing of a job associated with a first service is to be offloaded from the at least one processor to the first offload processing component. Additionally, the offload processing component may be configured to execute the instructions to determine a first set of supported service types associated with the first offload processing component and first resource availability information associated with the device. The offload processing component may also be configured to execute the instructions to identify, via the radio transceiver, a second device comprising a second offload processing component. The offload processing component may also be configured to execute the instructions to receive, from the second device, offload capability information and determine, based at least in part on the offload capability information, a second set of supported service types associated with the second offload processing component and second resource availability information associated with the second device. Furthermore, the offload processing component may also be configured to execute the instructions to determine, based at least in part on the second set of supported service types and the second resource availability information, whether to process the job via the first offload processing component or via the second offload processing component.

According to one or more embodiments of the disclosure, a method is provided. The method may include determining, by a computer including one or more processors, that processing of a job associated with a first service is to be offloaded from the one or more processors. The method may also include identifying a first device comprising a first offload processing component and a second device comprising a second offload processing component. Additionally, the method may include receiving, from the first device, first offload capability information, wherein the first offload capability information indicates a first set of supported service types associated with the first offload processing component and first resource availability information associated with the first device. The method may also include receiving, from the second device, second offload capability information, wherein the second offload capability information indicates a second set of supported service types associated with the second offload processing component and second resource availability information associated with the second device. The method may further include determining, based at least in part on the first offload capability information and the second offload capability information, whether to process the job via the first offload processing component or via the second offload processing component.

According to one or more embodiments of the disclosure, a non-transitory computer-readable medium is provided. The non-transitory computer-readable medium may have embodied thereon instructions executable by one or more processors. The instructions may cause the one or more processors to determine that processing of a job associated with a first service is to be offloaded from the one or more processors. Additionally, the computer-readable medium may include instructions to identify a first device comprising a first offload processing component and a second device comprising a second offload processing component. Moreover, the computer-readable medium may include instructions to receive, from the first device, first offload capability information, wherein the first offload capability information indicates a first set of supported service types associated with the first offload processing component and first resource availability information associated with the first device. The computer-readable medium may also include instructions to receive, from the second device, second offload capability information, wherein the second offload capability information indicates a second set of supported service types associated with the second offload processing component and second resource availability information associated with the second device. Furthermore, the computer-readable medium may also include instructions to determine, based at least in part on the first offload capability information and the second offload capability information, whether to process the job via the first offload processing component or via the second offload processing component.

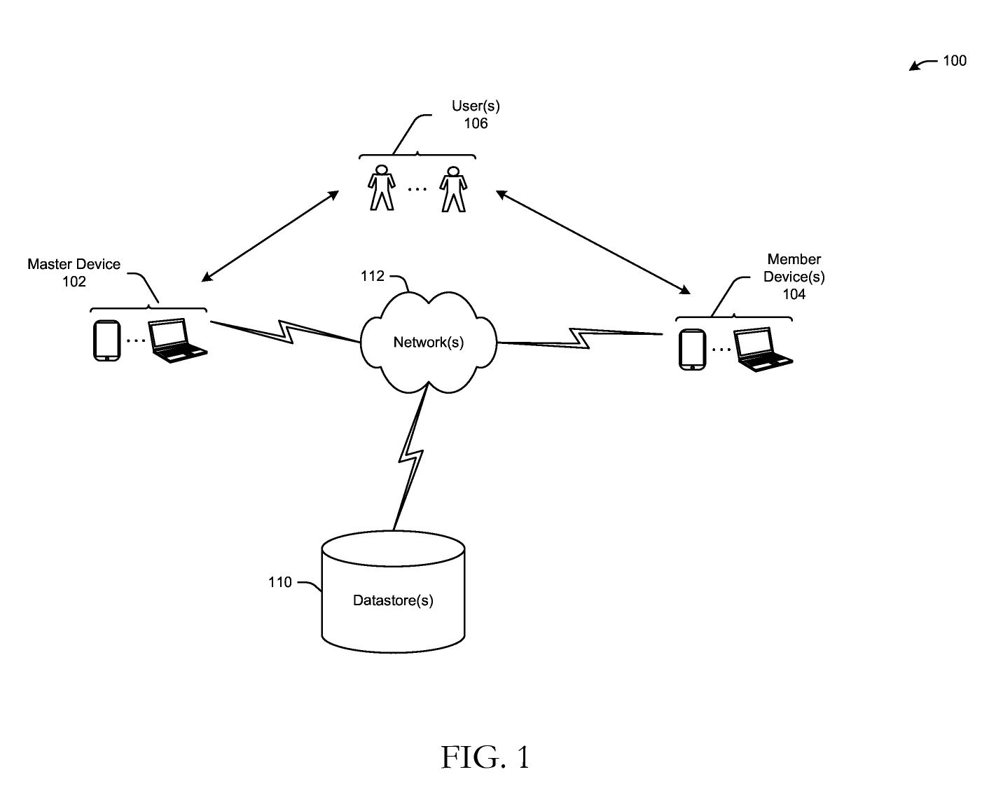

The above principles, as well as perhaps others, are now illustrated with reference to FIG. 1. FIG. 1 is a schematic diagram depicting an illustrative networked architecture 100 in accordance with one or more example embodiments of the disclosure. The illustrative architecture 100 may include one or more master devices 102, one or more member devices 104, and one or more datastores 110. The master device 102 and the member devices 104 may be operable by one or more users 106.

The master device 102 may include any suitable computing device including, without limitation, suitable user device including, without limitation, a smartphone or other cellular device, a tablet device, an electronic reader device, a desktop computing device, a laptop computing device, a gaming console, a multimedia content streaming device, a television such as Smart TV, or any other device capable of receiving content (e.g., web content) over one or more networks and rendering the content for presentation to a user. Similarly, the member device(s) 104 may also include any suitable user device including, without limitation, a smartphone or other cellular device, a tablet device, an electronic reader device, a desktop computing device, a laptop computing device, a gaming console, a multimedia content streaming device, a television such as Smart TV, or any other device capable of receiving content (e.g., web content) over one or more networks and rendering the content for presentation to a user. While various illustrative components of the architecture 100 may be described herein in the singular, it should be appreciated that multiple ones of any such components may be provided in various example embodiments of the disclosure.

The master device 102 and the member devices 104 may each be configured to communicate with one or more entities of the architecture 100 via one or more networks 112. The network(s) 112 may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, the network(s) 112 may have any suitable communication range associated therewith and may include, for example, global networks (e.g., the Internet), metropolitan area networks (MANs), wide area networks (WANs), local area networks (LANs), or personal area networks (PANs). In addition, the network(s) 112 may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

According to one or more embodiments, the master device may include a processor and a first offload processing component. The first offload processing component may be configured to process one or more services, or portions thereof, that are offloaded from the processor. A service may refer to any set of related software functionalities that can be processed for different purposes. Example services may include, but are not limited to, fixed location services, geo-fencing services, encryption/decryption services, other security related services, social network services, and/or any other set of functionalities. Typically, the processor of the master device 102 may be configured to process a service as plurality of jobs. However, in order to conserve power and/or free up CPU cycles for the processor, certain jobs that are included in the service may be offloaded to the first offloading processing component for processing.

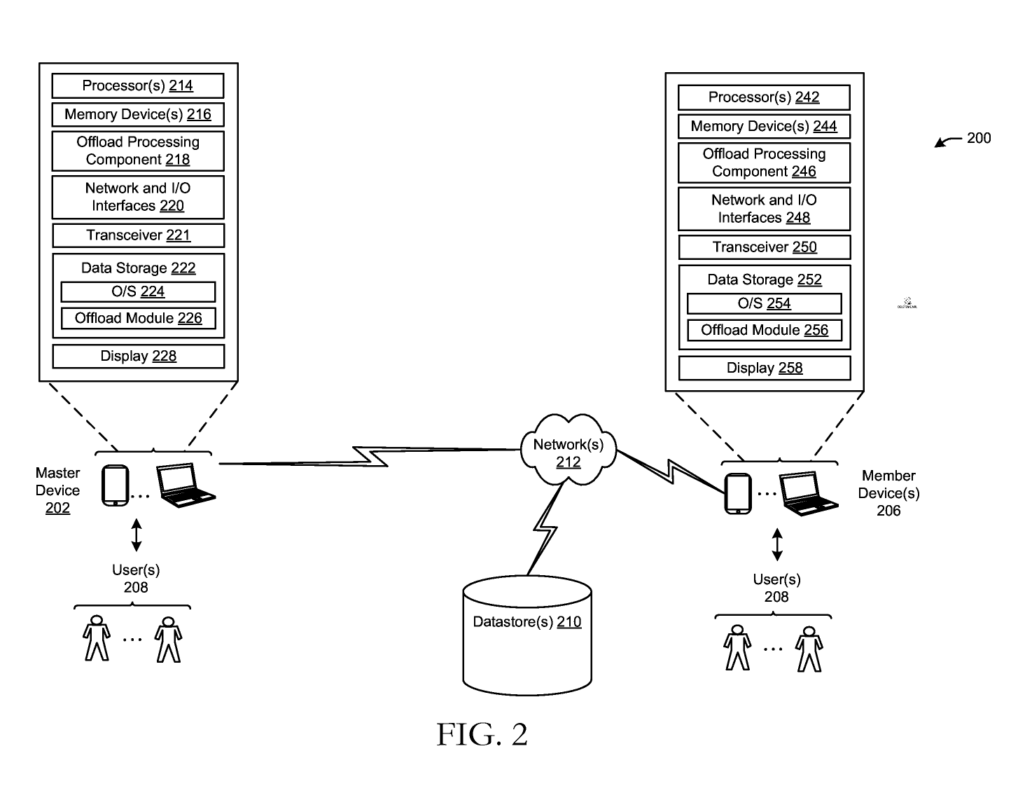

In certain embodiments, the first offloading processing component may further distribute processing of the jobs to one or more member devices 104. For instance, each of the member devices 104 may also include respective offload processing components to perform offloading related functions. As such, the master device 102 and/or the first offloading processing component may distribute the jobs of the service among the respective offload processing components of the member devices 104. This distribution may be based on various factors such as supported service types of the member device 104 and respective resource availability information associated with the master device 102 and the member devices 104. For instance, the jobs may only be distributed among member device 104 that support the service type of the service associated with the jobs (e.g., member device 104 that are capable of processing the service). Furthermore, member devices 104 that are associated with more available resources (e.g., available memory, battery level, and/or the like) may be prioritized for processing of the jobs over other member devices 104 that are associated with less available resources. The distribution of jobs are discussed in more detail with reference to FIG. 2.

FIG. 2 is a more detailed schematic block diagram of an illustrative system architecture 200 in accordance with one or more example embodiments of the disclosure. In certain example embodiments, the architecture 200 may represent a particular implementation or configuration of the architecture 100. For example, the master device 202 may represent a particular implementation or configuration of the master device 102 in accordance with one or more example embodiments of the disclosure. Further, the network(s) 212 may include any of the types of networks described through reference to the network(s) 112. It should be appreciated that FIG. 2 depicts merely example architectural and device configurations and that numerous modifications, variations, or the like are within the scope of this disclosure. Although certain elements in the following description may be described in the singular for purposes of clarity, it will be appreciated that such descriptions also apply to elements in the plural.

In an illustrative configuration, the master device 202 may include one or more processors (processor(s)) 214, one or more memory devices 216 (generically referred to herein as memory 216), a master offload processing component 218, one or more network and input/output (“I/O”) interface(s) 218, a transceiver 221, data storage 222, and a display 228. The master device 202 may also be in communication with one or more member devices 206 (hereinafter referred to in the singular). The member device 206 may include also include, similarly to the master device 202, one or more processors 242, memory devices 244, member offload processing components 246, network and I/O interfaces 248, a transceiver 250, data storage 252, and a display 258. These various components will be described in more detail hereinafter.

Referring back to the master device 202, the memory 216 may include volatile memory (memory that maintains its state when supplied with power) such as random access memory (RAM) and/or non-volatile memory (memory that maintains its state even when not supplied with power) such as read-only memory (ROM), flash memory, and so forth. In various implementations, the memory 216 may include multiple different types of memory, such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 216 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 222 may include removable storage and/or non-removable storage including, but not limited to, magnetic storage, optical disk storage, and/or tape storage. The data storage 222 may provide non-volatile storage of computer-executable instructions and other data. The data storage 222 may include storage that is internal and/or external to the master device 102. The memory 216 and the data storage 222, removable and/or non-removable, are examples of computer-readable storage media (CRSM) as that term is used herein.

The data storage 222 may store computer-executable instructions that are loadable into the memory 216 and executable by the processor(s) 214 and/or the master offload processing component 218 to cause various operations to be performed. The data storage 222 may additionally store data that may be copied to memory 216 for use by the processor(s) 214 and/or the master offload processing component 218 during the execution of the computer-executable instructions. Moreover, output data generated as a result of execution of the computer-executable instructions by the processor(s) 214 and/or the master offload processing component 218 may be stored initially in memory 216, and may ultimately be copied to data storage 222 for non-volatile storage.

More specifically, the data storage 222 may store one or more operating systems (O/S) 224; and one or more program modules, applications, or the like such as, for example, a master offload module 226.

The master offload module 226 may include computer-executable instructions that may cause the offload processing component 218 to perform operations for processing one or more services, or portions thereof, offloaded to the offload processing component 218 from the processor(s) 214. According to one or more embodiments, the master offload processing module 226 may determine that a job associated with a first service is to be offloaded from the processor(s) 214. For instance, this determination may include receiving an indication from the O/S 224 to offload the job from the processor(s) 214 to the master offload processing component 218. The master offload module 226 may also be configured to determine offload capability information associated with the master device 202. Such information may be stored in the memory 216, the data storage 222, the datastore 210, and/or any other storage device accessible by the master device 202. Furthermore, the offload capability information may indicate a first set of supported service types associated with the master offload processing component 218, which may indicate the types of services the offload processing component 218 is capable of performing and/or processing. To this end, the master offload module 226 may verify that a service type associated with the job and/or the first service is included in the first set of supported service types.

In addition, the capability information may also include first resource availability information indicating an amount of resources available to the master offload processing component 218 for processing the job associated with the first service. Resource availability information for a particular device (e.g., whether a master device 202 or a member device 206) may include a variety of factors, such as a battery level of the particular device, an amount of resource units available to the particular device (e.g., an amount of available memory), a distance between the particular device and the master device 202, and/or the like. Moreover, in certain implementations, the master offload module 226 may be configured to designate respective weight values associated with these factors depending on their statuses. For instance, the weight value associated with the battery level of the particular device may increase as the battery level increases and decrease as the battery level decreases. Similarly, the greater the amount of resource units available to the particular device, the greater the weight value associated with the amount of resource units. With respect to distance, the closer the distance between the particular device and the master device 202, the greater the weight value that may be associated with the distance. As such, the master offload module 226 may be configured to determine, based on the respective weight values of the factors include in the resource availability information, a resource score associated with particular device and/or an offload processing component of the particular device. According to one or more embodiments, the resource score may be a sum of respective weight values although other algorithms are also contemplated.

The master offload module 226 may also be configured to identify one or more member devices 206 that are within a predetermined proximity to the master device 202. For example, the master offload module 226 may direct the transceiver 221 to transmit a broadcast signal and identify any member devices 206 that respond to the broadcast signal (e.g., via their respective transceivers 250). Furthermore, the master offload module 226 may determine whether respective member devices of the identified member devices 206 belong to the same group as the master device. For instance, the master device 202 may be associated with a group identifier. The master offload module 226 may determine whether the respective member devices are associated with the same group identifier. If the master offload module 226 determines that the group identifier associated with the master device 202 matches a group identifier associated with a respective member device 206, the master offload module 226 may determine that the respective member device 206 belongs to the same group as the master device 202. In certain implementations, the master offload module 226 may distribute processing of the job of the first service among one or more respective member devices 206 that are in the same group as the master device 202.

According to one or more embodiments, the master offload module 226 may be configured to determine, based on respective offload capability information associated with a first device and a second device (e.g., the master device 202 and a member device 206 or two member devices 206), whether to distribute processing of the job associated to an offload processing component of the first device or an offload processing component of the second device. For instance, the master offload module 226 may determine first offload capability information associated with the first device. Based on the first offload capability information, the master offload module 226 may identify a first set of service types associated with a first offload processing component of the first device. Furthermore, based at least in part on first resource availability information included in the first offload capability information, the master offload module 226 may determine a first resource score associated with the first device. In addition, the master offload module 226 may request second offload capability information associated with the second device. For example, the master offload module 226 may receive, from the second device in response to the request, the second offload capability information, which may indicate a second set of service types associated with a second offload processing component of the second device. Furthermore, based at least in part on second resource availability information included in the second offload capability information, the master offload module 226 may determine a second resource score associated with the second device.

In certain implementations, the master offload module 226 may determine that the first set of service types includes a service type associated with the first service while the second set of service types does not include the service type associated with the first service. As a result, the master offload module 226 may determine that the job associated with the first service is to be processed by the first offload processing component of the first device. In other implementations, the master offload module 226 may determine that the first set of service types does not include the service type associated with the first service while the second set of service types does include the service type associated with the first service. As a result, the master offload module 226 may determine that the job associated with the first service is to be processed by the second offload processing component of the second device.

In other implementations, the master offload module 226 may determine that the service type associated with the first service is included in both the first set of service types and the second set of service types. As such, the master offload module 226 may be configured to compare the first resource score with the second resource score. If the first resource score is greater than the second resource score, the master offload module 226 may determine that the job is to be processed by first offload processing component associated with the first device. The master offload module 226 may then transmit the job to the first device to be processed by the first offload processing component. If the second resource score is greater than the first resource score, the master offload module 226 may determine that the job is to be processed by the second offload processing component associated with the second device. The master offload module 226 may then transmit the job to the second device to be processed by the second offload processing component.

Referring now to other illustrative components of the master device 202, the O/S 224 may be loaded into the memory 216 and may provide an interface between other application software executing on the master device 202 and hardware resources of the master device 202. More specifically, the O/S 224 may include a set of computer-executable instructions for managing hardware resources of the master device 202 and for providing common services to other application programs (e.g., managing memory allocation among various application programs). The O/S 224 may include any operating system now known or which may be developed in the future including, but not limited to, any server operating system, any mainframe operating system, or any other proprietary or non-proprietary operating system.

The processor(s) 214 and/or the master offload processing component 218 may be configured to access the memory 216 and execute computer-executable instructions stored therein. For example, the processor(s) 214 and/or the master offload processing component 218 may be configured to execute computer-executable instructions of the various program modules of the master device 202 to cause or facilitate various operations to be performed in accordance with one or more embodiments of the disclosure. The processor(s) 214 and/or the master offload processing component 218 may include any suitable processing unit capable of accepting data as input, processing the input data in accordance with stored computer-executable instructions, and generating output data. The processor(s) 214 and/or the master offload processing component 218 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 214 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 214 and/or the master offload processing component 218 may be capable of supporting any of a variety of instruction sets.

The master device 202 may further include one or more network and input/output (I/O) interfaces 220 that may facilitate the receipt of input information by the master device 202 from one or more I/O devices as well as the output of information from the master device 202 to the one or more I/O devices. The I/O devices may include, for example, one or more user interface devices that facilitate interaction between a user and the master device 202 including, but not limited to, a display, a keypad, a pointing device, a control panel, a touch screen display, a remote control device, a microphone, a speaker, and so forth. The I/O devices may further include, for example, any number of peripheral devices such as data storage devices, printing devices, and so forth.

The master device 202 may be configured to communicate with any of a variety of other systems, platforms, networks, devices, and so forth (e.g., a user device 206, etc.) via one or more of the network(s) 212. The master device 202 may include one or more network and I/O interfaces 220 that may facilitate communication between the master device 202 and any of the systems, networks, platforms, devices, or components of the system architecture 200.

Although not explicitly depicted or described, it should be appreciated that the member device(s) 206 may include similar hardware, software, or firmware components and/or additional or alternate hardware, software, or firmware components as those described through reference to the master device 202.

It should be appreciated that the program modules, applications, computer-executable instructions, code, or the like depicted in FIG. 2 as being stored in the data storage 222 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the master device 202, the member device(s) 206, and/or hosted on other computing device(s) accessible via one or more of the network(s) 212 may be provided to support functionality provided by the program modules, applications, or computer-executable code depicted in FIG. 2 and/or additional or alternate functionality. Further, functionality may be modularized differently such that processing described as being supported collectively by the collection of program modules depicted in FIG. 2 may be performed by a fewer or greater number of modules, or functionality described as being supported by any particular module may be supported, at least in part, by another module. In addition, program modules that support the functionality described herein may form part of one or more applications executable across any number of systems or devices of the system architecture 200 in accordance with any suitable computing model such as, for example, a client-server model, a peer-to-peer model, and so forth. In addition, any of the functionality described as being supported by any of the program modules depicted in FIG. 2 may be implemented, at least partially, in hardware and/or firmware across any number of devices.

It should further be appreciated that the master device 202, the member device(s) 206, or any other illustrative component of the system architecture 200 may include alternate and/or additional hardware, software, or firmware components beyond those described or depicted without departing from the scope of the disclosure. More particularly, it should be appreciated that software, firmware, or hardware components depicted as forming part of any entity included in the architecture 200 are merely illustrative and that some components may not be present or additional components may be provided in various embodiments. While various illustrative program modules have been depicted as software modules stored in data storage, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

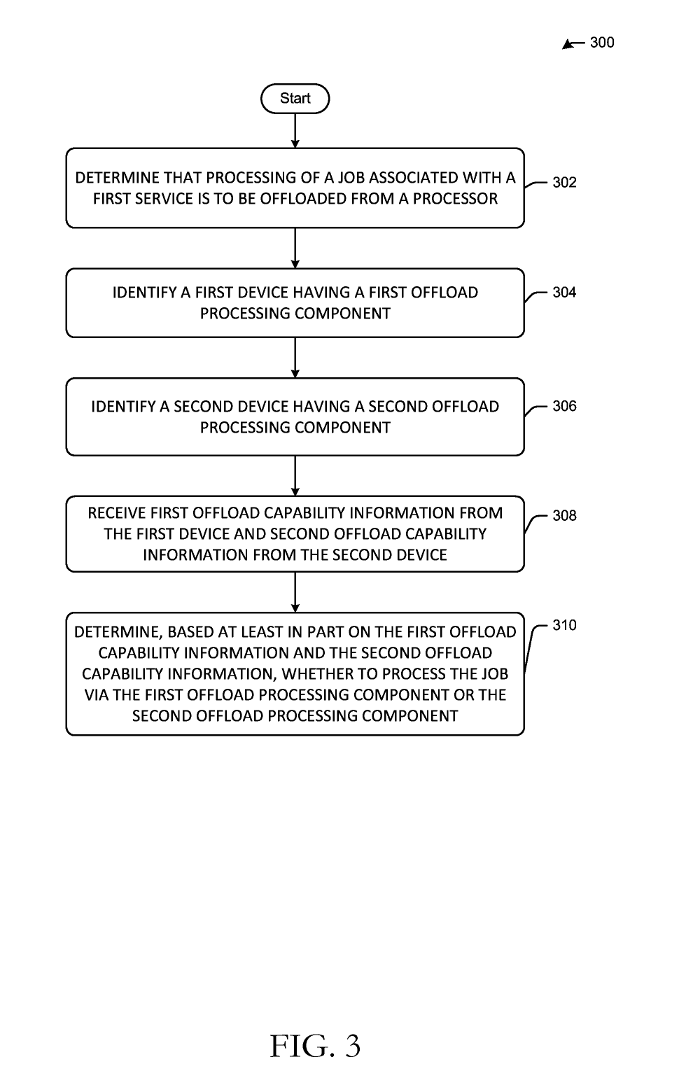

Referring now to FIG. 3, a flow diagram of a method 300 is illustrated for distributing offload service processing in accordance with one or more example embodiments. The method 300 may begin at block 302, where an offload module, such as the master offload module 226 of the master device 202, may determine that processing of a job associated with a first service is to be offloaded from a processor. In block 304, the master offload module 226 may identify a first device having a first offload processing component.

In block 306, the master offload module 226 may identify the second device having a second offload processing component. In certain implementations, the first device may be the master device 202 and the second device may be a member device 206. In other implementations, both the first device and the second device may be member devices 206. In block 308, the master offload module 226 may receive first offload capability information from the first device and second offload capability information from the second device. In block 310, the master offload module 226 may determine, based at least in part on the first offload capability information and the second offload capability information, whether to process the job via the first offload processing component or the second offload processing component.

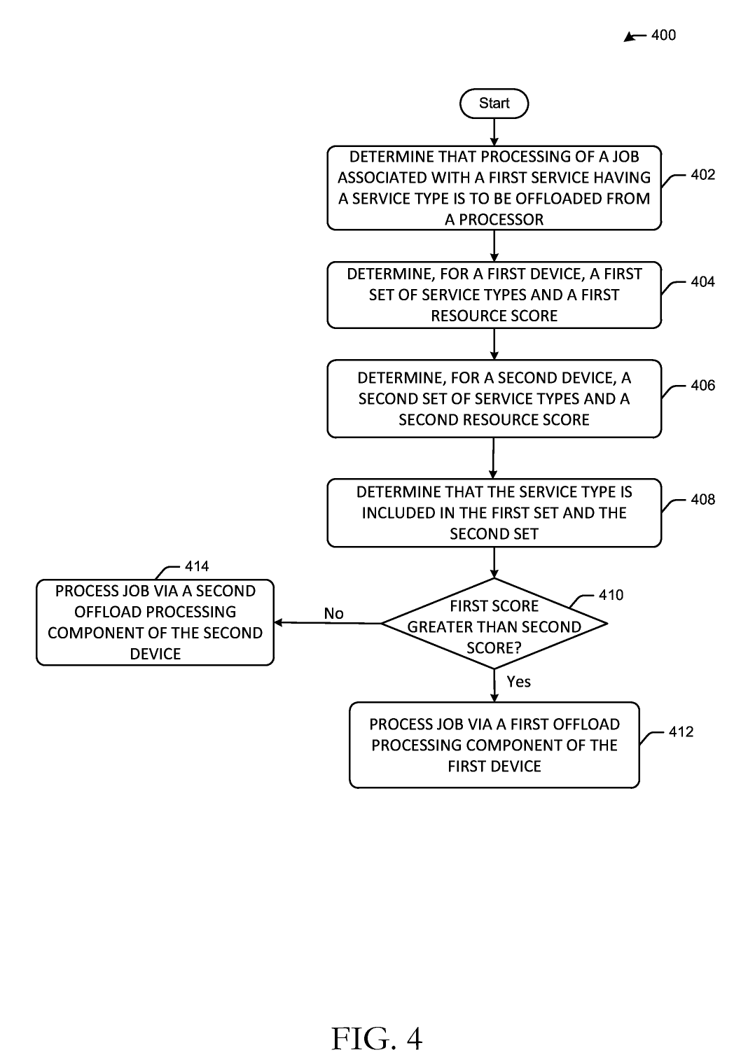

Referring now to FIG. 4, a flow diagram of another method 400 is illustrated for distributing offload service processing in accordance with one or more example embodiments. The method 400 may begin at block 402, where an offload module, such as the master offload module 226 of the master device 202, may determine that processing of a job associated with a first service is to be offloaded from a processor. In addition, the first service may be associated with a service type. In block 404, the master offload module 226 may determine, for a first device, a first set of service types and a first resource score.

In block 406, the master offload module 226 may determine, for a second device, a second set of service types and a second resource score. In block 408, the master offload module 226 may determine that the service type associated with the first service is included in the first set of service types and the second set of service types. In decision block 410, the master offload module 226 may determine whether the first resource score is greater than the second resource score. If so, the method 400 may proceed to block 412 in which the master offload module 226 may process the job via a first offload processing component associated with the first device. If not, the method 400 may proceed to block 412 in which the master offload module 226 may process the job via a second offload processing component associated with the second device.

Certain embodiments of the present disclosure are described above with reference to block and flow diagrams of systems and methods and/or computer program products according to example embodiments of the present disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the present disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the present disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the present disclosure have been described in connection with what is presently considered to be the most practical and various embodiments, it is to be understood that the present disclosure is not to be limited to the disclosed embodiments, but is intended to cover various modifications and equivalent arrangements included within the scope of the appended claims. Although specific terms are employed herein, they are used in a generic and descriptive sense only and not for purposes of limitation.

This written description uses examples to disclose certain embodiments of the present disclosure, including the best mode, and also to enable any person skilled in the art to practice certain embodiments of the present disclosure, including making and using any devices or systems and performing any incorporated methods. The patentable scope of certain embodiments of the present disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### EXAMPLES

Example 1 is a device for wireless communication, comprising: at least one antenna; a radio transceiver; at least one processor; a first offload processing component in communication with the at least one antenna, the radio transceiver, and the at least one processor; at least one memory storing computer-executable instructions, that when executed by the first offload processing component, causes the offload processing component to: determine that processing of a job associated with a first service is to be offloaded from the at least one processor to the first offload processing component; determine a first set of supported service types associated with the first offload processing component and first resource availability information associated with the device; identify, via the radio transceiver, a second device comprising a second offload processing component; receive, from the second device, offload capability information; determine, based at least in part on the offload capability information, a second set of supported service types associated with the second offload processing component and second resource availability information associated with the second device; and determine, based at least in part on the second set of supported service types and the second resource availability information, whether to process the job via the first offload processing component or via the second offload processing component.

In Example 2, the subject matter of Example 1 can optionally include that the first resource availability information comprises information associated with at least one of a first battery level, a first number of resource units, and a first distance associated with the device, and the second resource availability information comprises information associated with at least one of a second battery level, a second number of resource units, and a second distance between the second device and the device.

In Example 3, the subject matter of Example 1 can optionally include that the computer-executable instructions to determine whether to process the job via the first offload processing component or via the second offload processing component further causes the first offload processing component to: determine that a service type associated with the first service is included in the first set of supported service types and included in the second set of supported service types; determine, based at least in part on the first resource availability information, a first resource score associated with the first offload processing component; determine, based at least in part on the second resource availability information, a second resource score associated with the second offload processing component; and compare the first resource score with the second resource score.

In Example 4, the subject matter of Example 3 can optionally include that the computer-executable instructions further causes the first offload processing component to: determine, based at least in part on the comparison, that the first resource score is greater than the second resource score; determine that the job is to be processed via the first offload resource component; and process the job.

In Example 5, the subject matter of Example 3 can optionally include that the computer-executable instructions further cause the first offload processing component to: determine, based at least in part on the comparison, that the second resource score is greater than the first resource score; and transmit the job to the second device to be processed via the second offload processing component.

In Example 6, the subject matter of Example 1 can optionally include that the computer-executable instructions to determine whether to process the job via the first offload processing component or via the second offload processing component further causes the first offload processing component to: determine that a service type associated with the first service is not included in the second set of supported service types; and process the job via the first offload processing component.

In Example 7, the subject matter of Example 1 can optionally include that the computer-executable instructions to identify the second device further cause the first offload processing component to: determine that the second device is within a predetermined proximity to the device; determine that a first group identifier associated with the device matches a second group identifier associated with the second device.

Example 8 is a method for wireless communication, including: determining, by a computer including one or more processors, that processing of a job associated with a first service is to be offloaded from the one or more processors; identifying a first device comprising a first offload processing component and a second device comprising a second offload processing component; receiving, from the first device, first offload capability information, wherein the first offload capability information indicates a first set of supported service types associated with the first offload processing component and first resource availability information associated with the first device; receiving, from the second device, second offload capability information, wherein the second offload capability information indicates a second set of supported service types associated with the second offload processing component and second resource availability information associated with the second device; and determining, based at least in part on the first offload capability information and the second offload capability information, whether to process the job via the first offload processing component or via the second offload processing component.

In Example 9, the subject matter of Example 8 can optionally include that the first resource availability information comprises information associated with at least one of a first battery level, a first number of resource units, and a first distance associated with the first device; and the second resource availability information comprises information associated with at least one of a second battery level, a second number of resource units, and a second distance between the second device and the first device.

In Example 10, the subject matter of Example 8 can optionally include that determining whether to process the job via the first offload processing component or via the second offload processing component further comprises: determining that a service type associated with the first service is included in the first set of supported service types and included in the second set of supported service types; determining, based at least in part on the first resource availability information, a first resource score associated with the first offload processing component; determining, based at least in part on the second resource availability information, a second resource score associated with the second offload processing component; and comparing the first resource score with the second resource score..

In Example 11, the subject matter of Example 10 can optionally include that determining, based at least in part on the comparison, that the first resource score is greater than the second resource score; determining that the job is to be processed via the first offload resource component; and processing the job via the first offload resource component.

In Example 12, the subject matter of Example 10 can optionally include determining, based at least in part on the comparison, that the second resource score is greater than the first resource score; and transmitting the job to the second device to be processed via the second offload processing component.

In Example 13, the subject matter of Example 8 can optionally include that determining whether to process the job via the first offload processing component or via the second offload processing component further comprises: determining that a service type associated with the first service is not included in the second set of supported service types; and processing the job via the first offload processing component.

In Example 14, the subject matter of Example 8 can optionally include that identifying the first device and the second device further comprises: determining that the first device is within a predetermined proximity to the computer; determining that the second device is within the predetermined proximity to the computer; and determining that a group identifier associated with the computer matches a first group identifier associated with the first device and a second group identifier associated with the second device.

Example 15 is a non-transitory computer-readable medium comprising instructions, that when executed by at least one processor, cause the at least one processor to: determine that processing of a job associated with a first service is to be offloaded from the one or more processors; identify a first device comprising a first offload processing component and a second device comprising a second offload processing component; receive, from the first device, first offload capability information, wherein the first offload capability information indicates a first set of supported service types associated with the first offload processing component and first resource availability information associated with the first device; receive, from the second device, second offload capability information, wherein the second offload capability information indicates a second set of supported service types associated with the second offload processing component and second resource availability information associated with the second device; and determine, based at least in part on the first offload capability information and the second offload capability information, whether to process the job via the first offload processing component or via the second offload processing component.

In Example 16, the subject matter of Example 15 can optionally include that the first resource availability information comprises information associated with at least one of a first battery level, a first number of resource units, and a first distance associated with the first device; and the second resource availability information comprises information associated with at least one of a second battery level, a second number of resource units, and a second distance between the second device and the first device.

In Example 17, the subject matter of Example 15 can optionally include that the computer-executable instructions to determine whether to process the job via the first offload processing component or via the second offload processing component further causes the first offload processing component to: determine that a service type associated with the first service is included in the first set of supported service types and included in the second set of supported service types; determine, based at least in part on the first resource availability information, a first resource score associated with the first offload processing component; determine, based at least in part on the second resource availability information, a second resource score associated with the second offload processing component; and compare a first resource score with the second resource score.

In Example 18, the subject matter of Example 17 can optionally include that the computer-executable instructions further causes the first offload processing component to: determine, based at least in part on the comparison, that the first resource score is greater than the second resource score; determine that the job is to be processed via the first offload resource component; and process the job.

In Example 19, the subject matter of Example 17 can optionally include that the computer-executable instructions further cause the first offload processing component to: determine, based at least in part on the comparison, that the second resource score is greater than the first resource score; and transmit the job to the second device to be processed via the second offload processing component.

In Example 20, the subject matter of Example 17 can optionally include that the computer-executable instructions to determine whether to process the job via the first offload processing component or via the second offload processing component further causes the first offload processing component to: determine that a service type associated with the first service is not included in the first set of supported service types; and process the job via the first offload processing component.

Example 21 is an apparatus for wireless communication. The apparatus may include means for determining, by a computer comprising one or more processors, that processing of a job associated with a first service is to be offloaded from the one or more processors. The apparatus may include means for identifying a first device comprising a first offload processing component and a second device comprising a second offload processing component. The apparatus may include means for receiving, from the first device, first offload capability information, wherein the first offload capability information indicates a first set of supported service types associated with the first offload processing component and first resource availability information associated with the first device. The apparatus may include means for receiving, from the second device, second offload capability information, wherein the second offload capability information indicates a second set of supported service types associated with the second offload processing component and second resource availability information associated with the second device. The apparatus may include means for determining, based at least in part on the first offload capability information and the second offload capability information, whether to process the job via the first offload processing component or via the second offload processing component.

In Example 22, the subject matter of Example 21, can optionally include the first resource availability information comprises information associated with at least one of a first battery level, a first number of resource units, and a first distance associated with the first device; and the second resource availability information comprises information associated with at least one of a second battery level, a second number of resource units, and a second distance between the second device and the first device.

In Example 23, the subject matter of Example 21, can optionally include means for determining whether to process the job via the first offload processing component or via the second offload processing component further includes means for determining that a service type associated with the first service is included in the first set of supported service types and included in the second set of supported service types, means for determining, based at least in part on the first resource availability information, a first resource score associated with the first offload processing component, means for determining, based at least in part on the second resource availability information, a second resource score associated with the second offload processing component, and means for comparing the first resource score with the second resource score.

In Example 24, the subject matter of Example 21, can optionally include means for determining, based at least in part on the comparison, that the first resource score is greater than the second resource score, means for determining that the job is to be processed via the first offload resource component, and means for processing the job via the first offload resource component.

In Example 25, the subject matter of Example 21, can optionally include means for determining, based at least in part on the comparison, that the second resource score is greater than the first resource score, and means for transmitting the job to the second device to be processed via the second offload processing component.

In Example 26, the subject matter of Example 21, can optionally include means for determining whether to process the job via the first offload processing component or via the second offload processing component may further include means for determining that a service type associated with the first service is not included in the second set of supported service types, and means for processing the job via the first offload processing component.

In Example 27, the subject matter of Example 21, can optionally include means for identifying the first device and the second device may further include means for determining that the first device is within a predetermined proximity to the computer, means for determining that the second device is within the predetermined proximity to the computer, and means for determining that a group identifier associated with the computer matches a first group identifier associated with the first device and a second group identifier associated with the second device.

What is claimed is:

1. A device for wireless communication, comprising:
at least one antenna;
a radio transceiver;
at least one processor;
a first offload processing component in communication with the at least one antenna, the radio transceiver, and the at least one processor;
at least one memory storing computer-executable instructions, that when executed by the first offload processing component, causes the offload processing component to:
determine that processing of a job associated with a first service is to be offloaded from the at least one processor to the first offload processing component;
determine a first set of supported service types associated with the first offload processing component and first resource availability information associated with the device;
identify, via the radio transceiver, a second device comprising a second offload processing component;
receive, from the second device, offload capability information;
determine, based at least in part on the offload capability information, a second set of supported service types associated with the second offload processing component and second resource availability information associated with the second device; and
determine, based at least in part on the second set of supported service types and the second resource availability information, whether to process the job via the first offload processing component or via the second offload processing component.

2. The device of claim 1, wherein:
the first resource availability information comprises information associated with at least one of a first battery level, a first number of resource units, and a first distance associated with the device; and
the second resource availability information comprises information associated with at least one of a second battery level, a second number of resource units, and a second distance between the second device and the device.

3. The device of claim 1, wherein the computer-executable instructions to determine whether to process the job via the first offload processing component or via the second offload processing component further causes the first offload processing component to:
determine that a service type associated with the first service is included in the first set of supported service types and included in the second set of supported service types;
determine, based at least in part on the first resource availability information, a first resource score associated with the first offload processing component;
determine, based at least in part on the second resource availability information, a second resource score associated with the second offload processing component; and
compare the first resource score with the second resource score.

4. The device of claim 3, wherein the computer-executable instructions further causes the first offload processing component to:
determine, based at least in part on the comparison, that the first resource score is greater than the second resource score;
determine that the job is to be processed via the first offload resource component; and
process the job.

5. The device of claim 3, wherein the computer-executable instructions further cause the first offload processing component to:
determine, based at least in part on the comparison, that the second resource score is greater than the first resource score; and
transmit the job to the second device to be processed via the second offload processing component.

6. The device of claim 1, wherein the computer-executable instructions to determine whether to process the job via the first offload processing component or via the second offload processing component further causes the first offload processing component to:
determine that a service type associated with the first service is not included in the second set of supported service types; and
process the job via the first offload processing component.

7. The device of claim 1, wherein the computer-executable instructions to identify the second device further cause the first offload processing component to:
determine that the second device is within a predetermined proximity to the device;
determine that a first group identifier associated with the device matches a second group identifier associated with the second device.

8. A method for wireless communication, comprising:
determining, by a computer comprising one or more processors, that processing of a job associated with a first service is to be offloaded from the one or more processors;
identifying a first device comprising a first offload processing component and a second device comprising a second offload processing component;
receiving, from the first device, first offload capability information, wherein the first offload capability information indicates a first set of supported service types associated with the first offload processing component and first resource availability information associated with the first device;
receiving, from the second device, second offload capability information, wherein the second offload capability information indicates a second set of supported service types associated with the second offload processing component and second resource availability information associated with the second device; and
determining, based at least in part on the first offload capability information and the second offload capability information, whether to process the job via the first offload processing component or via the second offload processing component.

9. The method of claim 8, wherein:
the first resource availability information comprises information associated with at least one of a first battery level, a first number of resource units, and a first distance associated with the first device; and
the second resource availability information comprises information associated with at least one of a second battery level, a second number of resource units, and a second distance between the second device and the first device.

10. The method of claim 8, wherein determining whether to process the job via the first offload processing component or via the second offload processing component further comprises:
determining that a service type associated with the first service is included in the first set of supported service types and included in the second set of supported service types;
determining, based at least in part on the first resource availability information, a first resource score associated with the first offload processing component;
determining, based at least in part on the second resource availability information, a second resource score associated with the second offload processing component; and
comparing the first resource score with the second resource score.

11. The method of claim 10, further comprising:
determining, based at least in part on the comparison, that the first resource score is greater than the second resource score;
determining that the job is to be processed via the first offload resource component; and
processing the job via the first offload resource component.

12. The method of claim 10, further comprising:
determining, based at least in part on the comparison, that the second resource score is greater than the first resource score; and
transmitting the job to the second device to be processed via the second offload processing component.

13. The method of claim 8, wherein determining whether to process the job via the first offload processing component or via the second offload processing component further comprises:
determining that a service type associated with the first service is not included in the second set of supported service types; and
processing the job via the first offload processing component.

14. The method of claim 8, wherein identifying the first device and the second device further comprises:
determining that the first device is within a predetermined proximity to the computer;
determining that the second device is within the predetermined proximity to the computer; and
determining that a group identifier associated with the computer matches a first group identifier associated with the first device and a second group identifier associated with the second device.

15. A non-transitory computer-readable medium comprising instructions, that when executed by at least one processor, cause the at least one processor to:
determine that processing of a job associated with a first service is to be offloaded from the one or more processors;
identify a first device comprising a first offload processing component and a second device comprising a second offload processing component;
receive, from the first device, first offload capability information, wherein the first offload capability information indicates a first set of supported service types associated with the first offload processing component and first resource availability information associated with the first device;
receive, from the second device, second offload capability information, wherein the second offload capability information indicates a second set of supported service types associated with the second offload processing component and second resource availability information associated with the second device; and
determine, based at least in part on the first offload capability information and the second offload capability information, whether to process the job via the first offload processing component or via the second offload processing component.

16. The computer-readable medium of claim 15, wherein:
the first resource availability information comprises information associated with at least one of a first battery level, a first number of resource units, and a first distance associated with the first device; and
the second resource availability information comprises information associated with at least one of a second battery level, a second number of resource units, and a second distance between the second device and the first device.

17. The computer-readable medium of claim 15, wherein the computer-executable instructions to determine whether to process the job via the first offload processing component or via the second offload processing component further causes the first offload processing component to:
determine that a service type associated with the first service is included in the first set of supported service types and included in the second set of supported service types;
determine, based at least in part on the first resource availability information, a first resource score associated with the first offload processing component;
determine, based at least in part on the second resource availability information, a second resource score associated with the second offload processing component; and
compare a first resource score with the second resource score.

18. The computer-readable medium of claim 17, wherein the computer-executable instructions further causes the first offload processing component to:
determine, based at least in part on the comparison, that the first resource score is greater than the second resource score;
determine that the job is to be processed via the first offload resource component; and
process the job.

19. The computer-readable medium of claim 17, wherein the computer-executable instructions further cause the first offload processing component to:
determine, based at least in part on the comparison, that the second resource score is greater than the first resource score; and
transmit the job to the second device to be processed via the second offload processing component.

20. The computer-readable medium of claim 15, wherein the computer-executable instructions to determine whether to process the job via the first offload processing component or via the second offload processing component further causes the first offload processing component to:
determine that a service type associated with the first service is not included in the first set of supported service types; and
process the job via the first offload processing component.
